(19) United States
(12) Patent Application Publication
(10) Pub. No.: US 2015/0135010 A1
(43) Pub. Date: May 14, 2015

(54) HIGH AVAILABILITY SYSTEM, REPLICATOR AND METHOD

(71) Applicants: Scott Thomas MacQuarrie, Toronto (CA); Patrick John Philips, Toronto (CA); Tudor Morosan, Toronto (CA); Gregory Arthur Allen, Toronto (CA)

(72) Inventors: Scott Thomas MacQuarrie, Toronto (CA); Patrick John Philips, Toronto (CA); Tudor Morosan, Toronto (CA); Gregory Arthur Allen, Toronto (CA)

(21) Appl. No.: 14/343,344

(22) PCT Filed: Sep. 7, 2012
(86) PCT No.: PCT/CA2012/000829

§ 371 Date: Jul. 10, 2014

Related U.S. Application Data
(60) Provisional application No. 61/531,873, filed on Sep. 7, 2011.

(51) Int. Cl. G06F 11/14

(52) U.S. Cl. CPC G06F 11/1448; G06F 2201/845
USPC 714/20

(57) ABSTRACT

The present specification provides a high availability system. In one aspect a replicator is situated between a plurality of servers and a network. Each server is configured to execute a plurality of identical message processors. The replicator is configured to forward messages to two or more of the identical message processors, and to accept a response to the message as being valid if there is a quorum of identical responses.

### CROSS-REFERENCE TO RELATED APPLICATION

This application claims priority to of U.S. Patent Application No. 61/531,873 filed Sep. 7, 2011, the contents of which are incorporated herein by reference.

### FIELD

The present specification relates generally to computing devices and more specifically relates to a high availability system.

### BACKGROUND

With ever increasing reliance on computing systems, it is problematic if those systems become unavailable. Furthermore, computer systems are increasingly accessed via networks, and yet those networks often suffer from latency issues.

### SUMMARY

In accordance with an aspect of the specification, there is provided a high availability system. The high availability system includes a replicator connectable to a network. The replicators is configured to receive a message from the network and to forward the message. Furthermore, the high availability system includes a plurality of servers connected to the replicator. Each of the servers is configured to receive the message forwarded by the replicator. In addition, the high availability system includes at least one message processor in each of the servers. The at least one message processor is configured to process the message, to generate a processor response message and to return the processor response message to the replicator. The replicator is further configured to generate a validated response message based on the processor response messages.

The replicator may be further configured to determine whether each of the processor response messages from the plurality of servers is equal to every other processor response message.

The replicator may be further configured to determine whether there is a quorum of equal processor response messages from the plurality of servers.

The high availability system may further include a memory storage unit configured to maintain a failure log file for logging a failure. The failure may be based on whether there is a quorum.

The replicator may be further configured to associate the message with the at least one message processor.

The replicator may be further configured to match the message with the at least one message processor in an association log file.

Each of the at least one message processors may include a protocol converter configured to convert the message in one of a plurality of protocols into a standardized format.

The high availability system may further include a session manager in each of the servers. The session manager may be configured to monitor health of each of the servers.

The high availability system may further include a recovery manager in each of the servers. The recovery manager may be configured to manage the introduction of an additional server.

The high availability system may further include a secondary replicator connectable to the plurality of servers and the network. The secondary replicator may be configured to assume functionality of the first replicator.

In accordance with another aspect of the specification, there is provided a replicator. The replicator includes a memory storage unit. Furthermore, the replicator includes a network interface configured to receive a message from a network. In addition, the replicator includes a replicator processor connected to the memory storage unit and the network interface. The replicator processor is configured to forward the message to a plurality of servers. Each of the servers is configured to process the message, to generate a processor response message, and to return the processor response message. The replicator processor is further configured to generate a validated response message based on the processor response messages from the plurality of servers.

The replicator processor may be further configured to determine whether each of the processor response messages from the plurality of servers is equal to every other processor response message.

The replicator processor may be further configured to determine whether there is a quorum of equal processor response messages from the plurality of servers.

The replicator processor may be further configured to associate the message with at least one message processor.

The replicator processor may be further configured to match the message with the at least one message processor in an association log file.

The memory storage unit may be configured to maintaining a failure log file for logging a failure, the failure based on whether there is a quorum.

In accordance with another aspect of the specification, there is provided a high availability method. The method involves receiving, at a replicator, a message from a network. Furthermore, the method involves forwarding the message from the replicator to a plurality of servers, each of the servers having at least one message processor, the at least one message processor configured to process the message, to generate a processor response message, and to return the processor response message to the replicator. In addition, the method involves generating, at the replicator, a validated response message based on the processor response messages from the plurality of servers.

The method may further involve determining whether each of the processor response messages from the plurality of servers is equal to every other processor response message.

The method may further involve determining whether there is a quorum of equal processor response messages from the plurality of servers.

The method may further involve logging a failure in a failure log file, wherein the failure is based on determining whether there is a quorum.

The method may further involve associating the message with the at least one message processor. n

Associating may involve matching the message with the at least one message processor in an association log file.

Receiving the message comprises receiving the may involve in one of a plurality of protocols. The message may be convertable to a standard format by a protocol converter in at least one of the plurality of message processors.

The method may further involve evaluating each of the servers using a session manager configured to monitor health of each of the servers.

The method may further involve managing the introduction of an additional server using a recovery manager.

The method may further involve assessing health of the replicator using a health link.

The method may further involve assuming functionality of the replicator with a secondary replicator when the first replicator fails.

### BRIEF DESCRIPTION OF THE DRAWINGS

FIG. 1 is a schematic representation of a high availability system.

FIG. 2 is a flow chart depicting a high availability method.

FIG. 3 shows the system of FIG. 1 during exemplary performance of part of the method of FIG. 2.

FIG. 4 shows the system of FIG. 1 during exemplary performance of part of the method of FIG. 2.

FIG. 5 shows the system of FIG. 1 during exemplary performance of part of the method of FIG. 2.

FIG. 6 shows the system of FIG. 1 during exemplary performance of part of the method of FIG. 2.

FIG. 7 is a flow chart depicting another high availability method.

FIG. 8 shows an example of a variation on the message processors from the system of FIG. 1 that incorporates protocol conversion.

FIG. 9 shows the message processor of FIG. 7 with exemplary message processing.

FIG. 10 shows a schematic representation of another high availability system.

FIG. 11 shows a schematic representation of another high availability system.

### DETAILED DESCRIPTION OF THE EMBODIMENTS

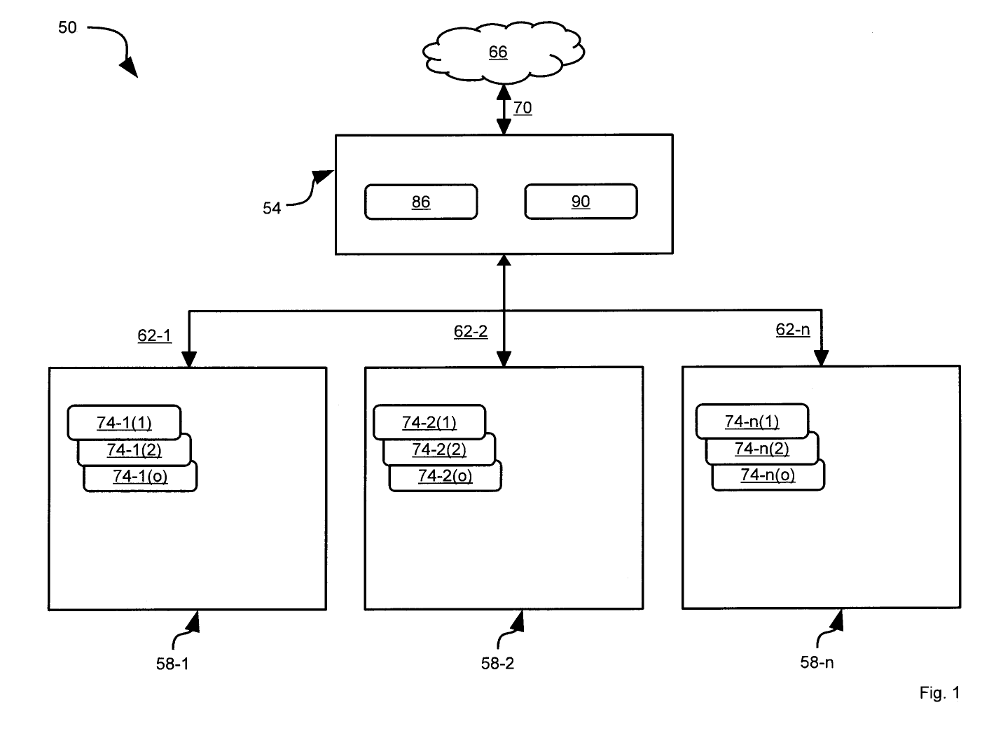

FIG. 1 a schematic representation of a non-limiting example of a high availability system 50 which can be used for processing messages. System 50 comprises a replicator 54 that connects to a plurality of servers 58-1, 58-2 . . . 58-n that actually process the messages. (Generically, server 58 and collectively servers 58. This nomenclature is used elsewhere herein.) While more than two servers 58 are shown, a minimum of two servers 58 is contemplated. A physical link 62 is used to connect replicator 54 to its respective server 58. Replicator 54 also connects to a network 66 via a link 70. Network 66 is the source of the messages that are processed by servers 58, and also the destination of processed messages.

System 50 can be used in a variety of different technical applications, but one example application is electronic trading. In this context the servers 58 can be implemented as trading engines, and the messages can contain data representations for orders to buy and sell securities or the like. In this example the trading engine is configured to match orders to buy and sell securities or the like. For convenience, specific reference to the electronic trading example will be made in the subsequent discussion, but it should be understood that other technical applications are contemplated.

Replicator 54 and each server 58 can be implemented on its own unique physical hardware, or one or more of them can be implemented in a cloud-computing context as one or more virtual servers. In any event, those skilled in the art will appreciate that an underlying configuration of interconnected processor(s), non-volatile memory storage unit, volatile memory storage unit and network interface(s) can be used to implement replicator 54 and each server 58. In a present implementation, replicator 54 and each server 58 are implemented as unique and separate pieces of hardware, while links 62 and link 70 are implemented as ten gigabit Ethernet connections.

Each server 58 is configured to maintain a plurality of message processors 74. Message processors 74 are identified using the following nomenclature: 74-X(Y), where “X” refers to the server number and “Y” refers to the particular message processor that is executing on that server. Message processors 74 are typically implemented as individual software threads executing on the one or more processors respective to its server 58. Message processors 74 are also typically configured to execute independently from any operating system executing on its respective server 58, in order to reduce jitter and contention with other services that are executing at the operating system layer. Expressed differently, message processors 74 are configured, in a present embodiment, to run at the same computing level as any operating system. Message processors 74 are thus configured to actually process the messages received via network 66 and to provide a response to those messages. Message processors 74 will be discussed further below.

Replicator 54 is configured to maintain a replication process 86 and a quorum process 90. Replication process 86 is configured to replicate messages received from network 66 and forward those messages to one of the message processors 74 on each server 58. Quorum process 90 is configured to receive responses from message processors 74 and evaluate them for consistency. Replication process 86 and a quorum process 90 will each be discussed further below.

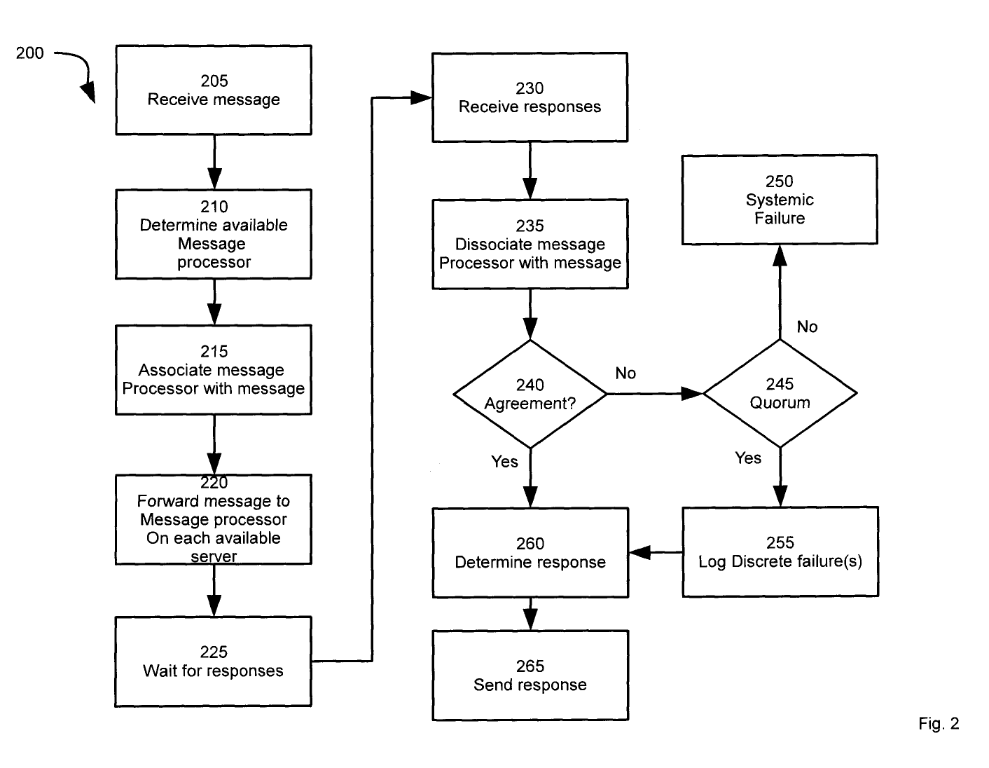

Referring now to FIG. 2, a flowchart depicting a high availability method for processing messages is indicated generally at 200. Method 200 is one way in which replicator 54, working in conjunction with servers 58, can be implemented. It is to be emphasized, however, that method 200 and need not be performed in the exact sequence as shown; hence the elements of method 200 are referred to herein as “blocks” rather than “steps”. It is also to be understood, however, that method 200 can be implemented on variations of system 50 as well.

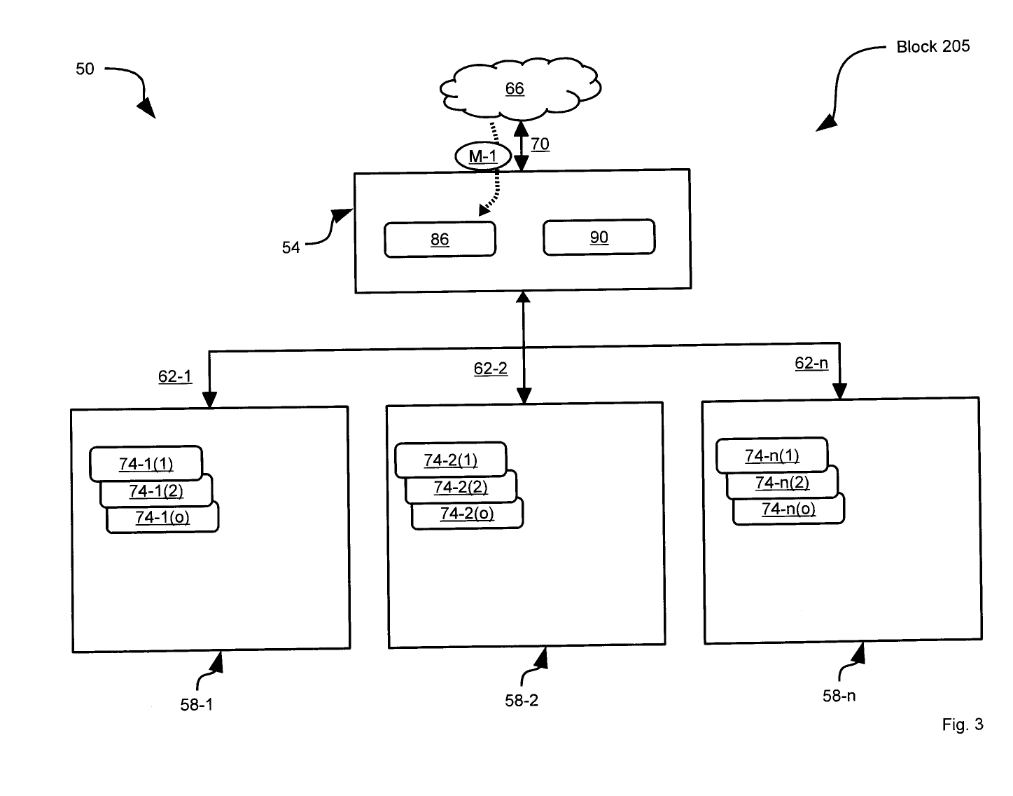

Block 205 thus comprises receiving a message. In relation to system 50, it is assumed that such a message from network 66 is received at replicator 54, and specifically received at replication process 86. This example is shown in FIG. 3 as a message M-1 is shown as received at replication process 86 from network 66, but it is to be understood that is a non-limiting example.

In the context of electronic trading, message M-1 can comprise, for example, data representing an order to buy or sell a given security or other fungible instrument and thus message M-1 can be generated at any client machine connectable to system 50 in order to generate such a message and direct that message to system 50. Message M-1 can also comprise other types of messages, such as an instruction to cancel an order.

Block 210 comprises determining an available message processor. Again, in an electronic trading environment, each message processor 74 can be uniquely associated with one or more specific fungible instruments, such as a given stock symbol. In this context, block 210 will comprise determining which stock symbol is associated with message M-1, and to then locate which message processor 74 is associated with stock symbol. In the non-limiting example discussed herein, it will be assumed that message processor 74-1 is associated with the stock symbol associated with message M-1.

Block 215 comprises associating the message received at block 205 with the processor determined at block 210. Block 215 can thus be implemented by an association log file maintained within replicator 54 that tracks the fact that message M-1 has been received and is being associated with message processor 74-1. For example, associating can involve matching entries of message types in the association log file with associated message processors.

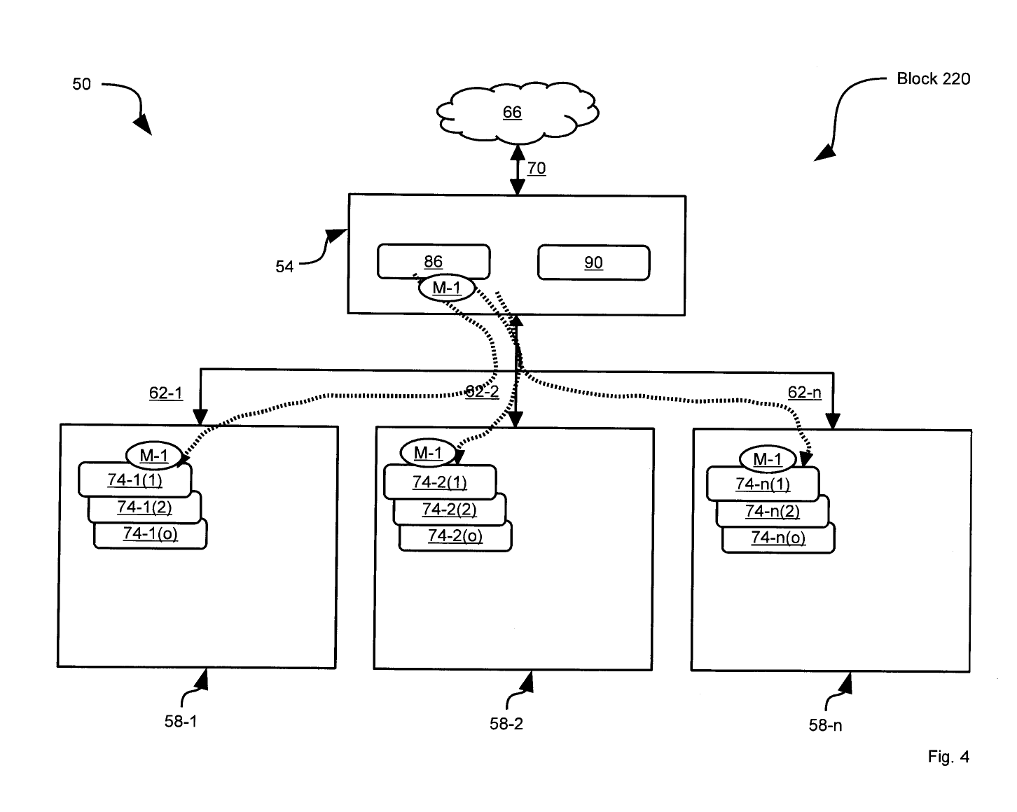

Block 220 comprises forwarding the message received at block 205 to the message processor on each available server. Exemplary performance of block 220 is shown in FIG. 4. In the specific example of system 50, there are “n” servers and it is assumed that all of them are in production. Accordingly, this example performance of block 220 comprises sending message M-1 to message processor 74-1(1) of server 58-1; message processor 74-2(1) of server 58-2, and to message processor 74-n(1) of server 58-n.

Block 225 comprises waiting for responses. Block 225 thus contemplates that each message processor 74-1 on each active server 58 will process message M-1 according to how that message processor 74-1 is configured. Non-limiting examples of how message processors 74 can be configured will be discussed further below. In general, however, it is contemplated that each message processor 74 is configured substantially identically, so that each message processor 74 will process messages in a deterministic manner. In other words, it is expected that the result returned from each message processor 74 will be identical.

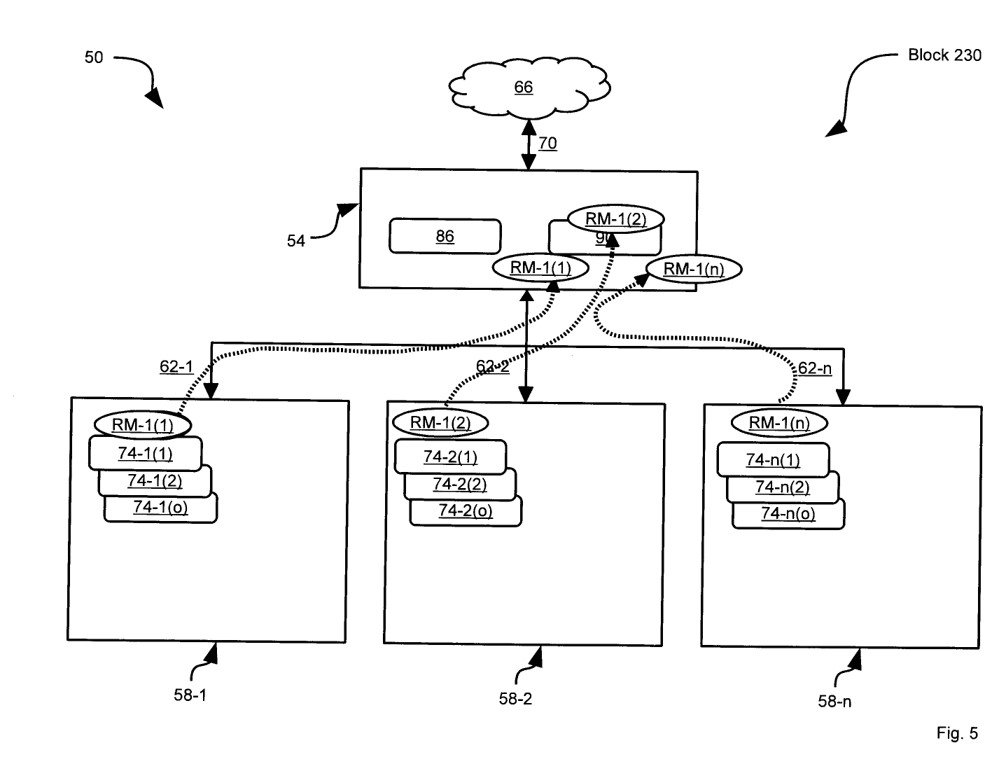

Block 230 thus comprises receiving responses from the message processors that were sent the message at block 220. While not shown in FIG. 2, it is contemplated that various status threads can also run in conjunction with method 200, such that if a particular server 58 or a particular message processor 74 were to fail during block 225, then method 200 can be configured to cease waiting for a response from that server 58. Performance of block 230 is represented in FIG. 5 as a first processor response message RM-1(1) is sent from message processor 74-1(1) to replicator 54; a second processor response message RM-1(2) is sent from message processor 74-1(2) to replicator 54; and a third processor response message RM-1(n) is sent from message processor 74-1(n) to replicator 54. In the present specific example, processor response messages RM-1(1), RM-1(2), and RM-1(n) are all received at quorum process 90 within replicator 54.

Block 235 comprises dissociating the message processor with the message received at block 205, effectively reversing the performance of block 215. In this manner, replicator 54 can track that a response to the message received at block 205 has been received.

Block 240 comprises determining if there was an agreement amongst the responses received at block 230. In the present example, if first processor response message RM-1(1) is equivalent to second processor response message RM-1(2) and to another processor response message RM-1(n), then a “yes” determination is made at block 240 and method 200 advances to block 260. On the other hand, if there is any disagreement or inequality amongst first processor response message RM-1(1), second processor response message RM-1(2) and another processor response message RM-1(n), then a “no” determination is made at block 240.

Block 245 comprises determining whether there is at least a quorum amongst the responses received at block 230, even if all of those responses are not in agreement. The definition of a quorum is not particularly limited, but typically is comprised of having at least two responses at block 230 being in agreement. If none of the responses are in agreement, then a ‘no’ determination is made at block 245 and method 200 advances to block 250 where a systemic failure is logged in a failure log file and method 200 ends. Method 200 can be recommenced when the systemic failure is rectified, whether such rectification is through some sort of automated or manual recovery process. It is contemplated that replicator 54 can be configured to implement a retry strategy to send the message for processing to servers 58 after a defined period of time, and to otherwise deem a complete failure to process the message after another defined period of time. Optionally, in the event of a complete failure, error reporting can be implemented as part of block 250, whereby the originator of the message received at block 205 receives an error response indicating that the message could not be processed.

If a quorum is found at block 245, then a “yes” determination is made and method 200 advances to block 255. At block 255, the disagreement is logged in the failure log file for further troubleshooting or other exception handling. Such exception handling can be automated or manual. For example, an automated exception handling can comprise logging when a certain number of disagreements have been logged for a given message processor or server, and to then make such a server unavailable until servicing of that server has occurred. Other types of exception handling can be effected as a result of the logging information captured at block 255. Although the present embodiment uses the same failure log files to record the systematic failures from block 250 and the discrete failures from block 255, it is to be appreciated that different log files can be used.

At block 260, a final response is determined based on the responses received at block 230. Where block 260 is reached from block 240, then the determined response comprises any one of the responses received at block 230. Where block 260 is reached from block 255, then the determined response comprises which of the responses were in agreement so as to satisfy the quorum at block 245.

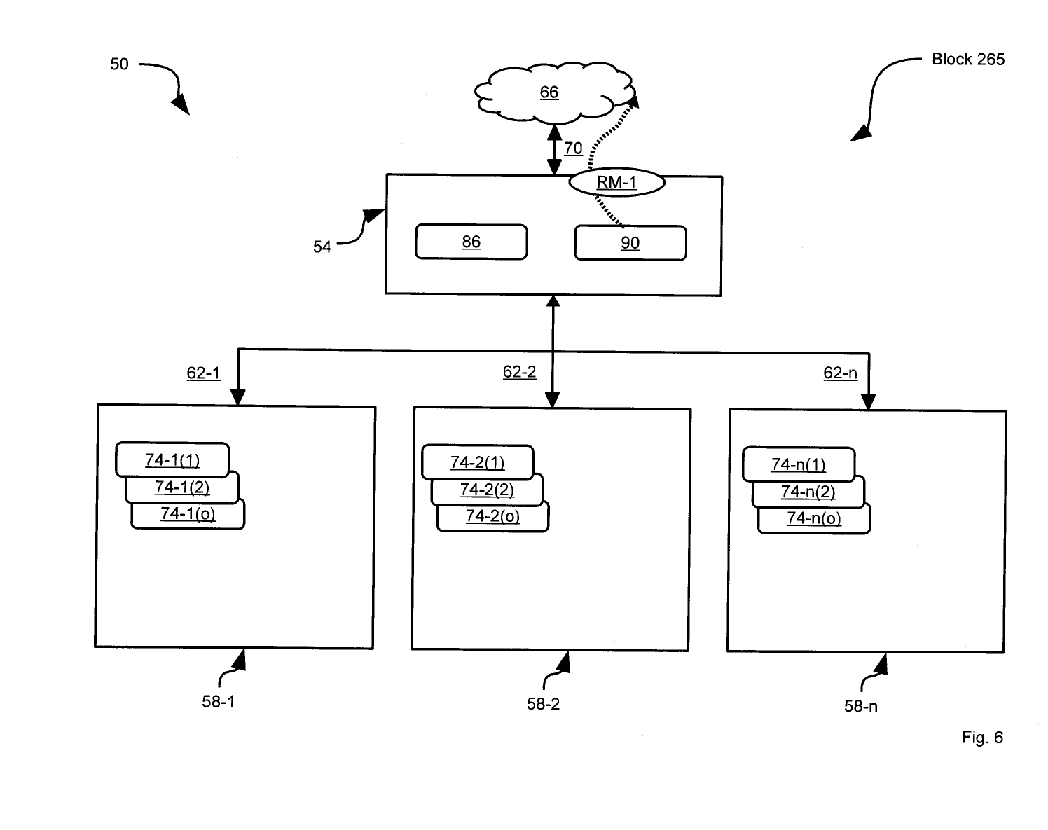

In the example of FIG. 5, assume that first processor response message RM-1(1) is equivalent to second processor response message RM-1(2) which is equivalent to another processor response message RM-1(n). On this basis, the final response as determined at block 260 can equal any one of first processor response message RM-1(1) is equivalent to second processor response message RM-1(2) which is equivalent to another processor response message RM-1(n). Thus, at block 265 the response as determined at block 260 is actually sent. Performance of block 265 is represented in FIG. 6, as validated response message RM-1 is sent back over network 66. Typically, though not necessarily, validated response message RM-1 is sent back to the original source of M-1 as received at block 205.

It should be understood that multiple instances of method 200 can be running concurrently to facilitate processing of each message as it is received at replicator 54.

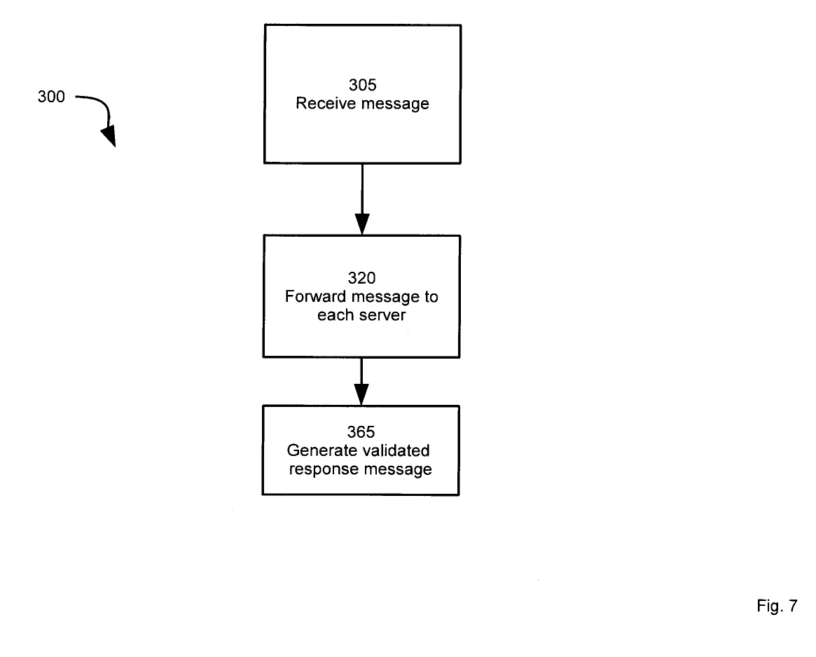

Referring now to FIG. 7, a flowchart depicting another high availability method for processing messages is indicated generally at 300. Method 300 is another way in which replicator 54, working in conjunction with servers 58, can be implemented. It is also to be understood, however, that method 300 can be implemented on variations of system 50 as well.

Block 305 thus comprises receiving a message and is similar to block 205 described above. In relation to system 50, it is assumed that such a message from network 66 is received at replicator 54, and specifically received at replication process 86.

In the context of electronic trading, the message can comprise, for example, data representing an order to buy or sell a given security or other fungible instrument and thus the message can be generated at any client machine connectable to system 50 in order to generate such a message and direct that message to system 50. In another example, the message can comprise other types of messages such as an instruction to cancel an order.

Block 320 comprises forwarding the message received at block 305 to the message processor of a plurality of servers. The performance of block 320 is similar to the performance of block 220 described in the previous embodiment.

At block 365, a final response is determined based on processor responses messages received from each server 58. The replicator 54 generates a validated response message for transmitting the final response to the network and ultimately to the source of the message.

The foregoing provides illustrative examples implementation, which persons skilled in the art will now appreciate encompasses a number of variations and enhancements. For example, different messages M can comprise orders to buy and sell particular securities. In this situation message processors 74 are configured to match such buy order messages M and sell order messages M. Accordingly, message processors 74 will store a given buy message M and not process that buy message M until a matching sell message M is received. In this context, the processing of the buy message M and the sell message M comprises generating a first response message RM responsive to the buy message M indicating that there has been a match, and second response message RM to the sell message M indicating that there has been a match. Further order matching techniques are contemplated, such as partial order matching, whereby, for example, a plurality of sell order messages M may be needed to satisfy a given buy order message M. Thus method 200, when implemented in an electronic trading environment can be configured to accommodate such order matching as part of handling messages M. Those skilled in the art will now recognize that requiring an agreement or a quorum as per method 200 can help ensure that responses to such messages are managed deterministically, and by having a plurality of message processors 74 a failure of one or more message processors 74 or servers 58 need not disrupt the ongoing processing of messages, thereby providing a high-availability system.

In the electronic trading context, in order to scale so as to permit the processing of high numbers of messages associated with different securities, then specific message processors 74 can be assigned to specific ranges of securities. For example, if system 50 is assigned to process electronic trades for 99 different types of securities, then message processors 74(1) can be assigned to a first block of 33 securities; and message processors 74(2) can be assigned to a second block of 33 securities, while message processors 74(o) can be assigned to a third block of 33 securities. Also note that the number of securities need not be equally divided amongst message processors 74, but rather the number of securities can be divided based on number of messages M that are to be processed in relation to such securities, so that load balancing is achieved between each of the message processors 74.

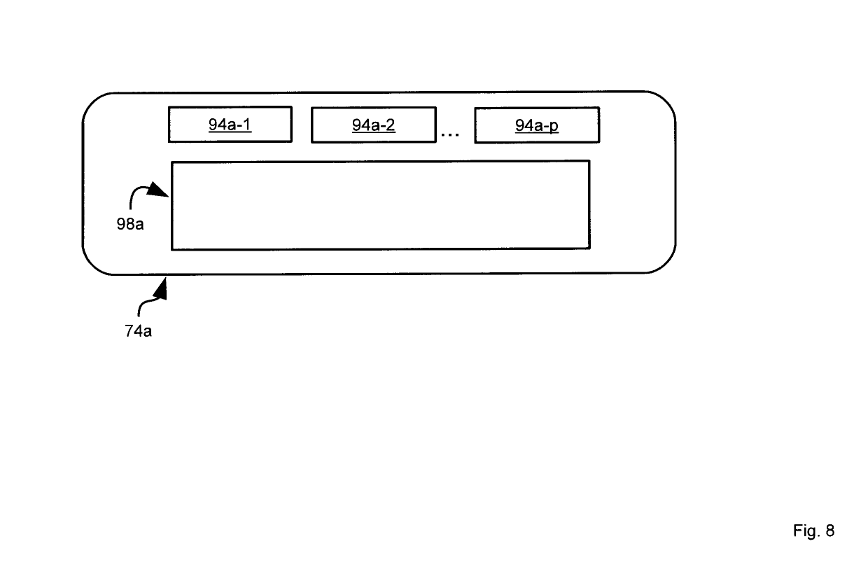

In another variation, an enhanced message processor 74a is provided as shown in FIG. 8. Enhanced message processor 74a is a variation on message processor 74 and accordingly message processor 74a bears the same reference as message processor 74, but followed by the suffix “a”. Thus, message processor 74a is one way, but not the only way, that message processor 74 can be implemented. Enhanced message processor 74a includes a plurality of protocol converters 94a and a processing object 98a. Such protocol converters 94a and processing object 98a are typically implemented as part of the overall software process that constitutes message processor 74a. By the same token message processor 74a also comprises a processing object 98 which actually performs the processing of messages once they are in normalized from their disparate protocols into a standard format.

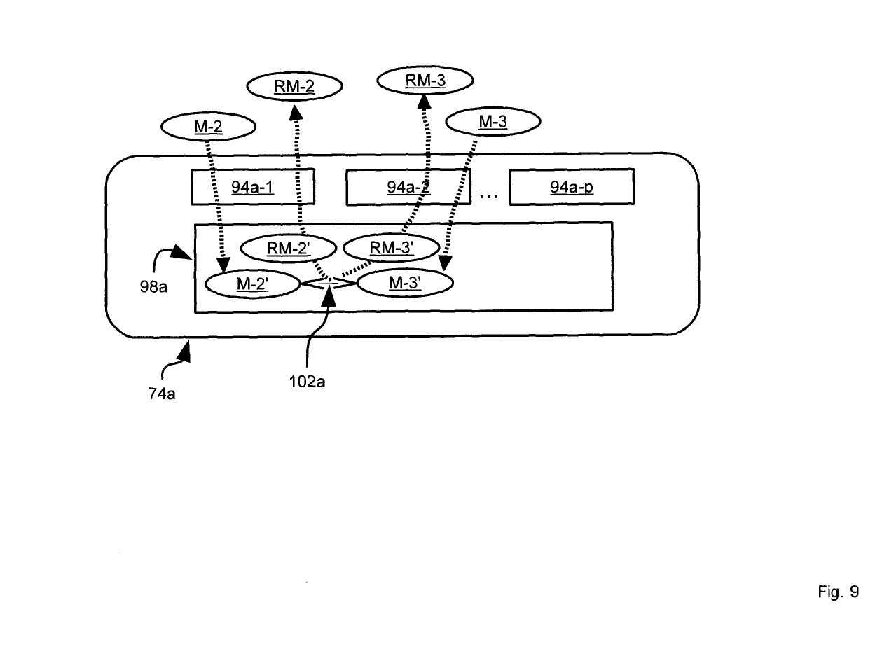

A non-limiting illustrative example (which builds on the schematic of FIG. 8) is shown in FIG. 9. Indeed, in the electronic trading environment it is contemplated that messages M may be received at block 205 in a plurality of different protocols. Two non-limiting examples of such protocols comprise the Financial Information eXchange (FIX) Protocol and the Securities Trading Access Messaging Protocol (STAMP). Accordingly, protocol converter 94-1 can be associated with the FIX protocol while converter 94a-2 can be associated with the STAMP protocol. Continuing with the example assume that message M-2 is received in the FIX protocol and comprises a buy order for a given security. Message M-2 is thus received at protocol converter 94a-1 and converted into standardized format which is then received as standardized message M-2′ at processing object 98a. Continuing with the same example also assume that message M-3 is received in the STAMP protocol and comprises a sell order for the same security as message M-3. Message M-3 is thus received at protocol converter 94a-2 and converted into standardized format which is then received as standardized message M-3′ at processing object 98a. Processing object can then match the buy order within standardized message M-2′ with the sell order within standardized message M-3′, and then generate processor response message RM-2′ indicating the match, and processor response message RM-3′ which also indicates the match. (The match is represented by the bidirectional arrow indicated at reference 102.) Processor response message RM-2′ is then sent back through protocol converter 94a-1 where it is converted into the FIX format and destined for delivery back to the originator or message M-2. Processor response message RM-3′ is sent back through protocol converter 94a-2 where it is converted into the STAMP format and destined for delivery back to the originator of message M-3.

Those skilled in the art will now recognize that protocol converters 94a can obviate the need for a separate protocol conversion unit to be located along link 66 from FIG. 1, which thereby mitigates against another possible point of failure and a point that can contribute to latency.

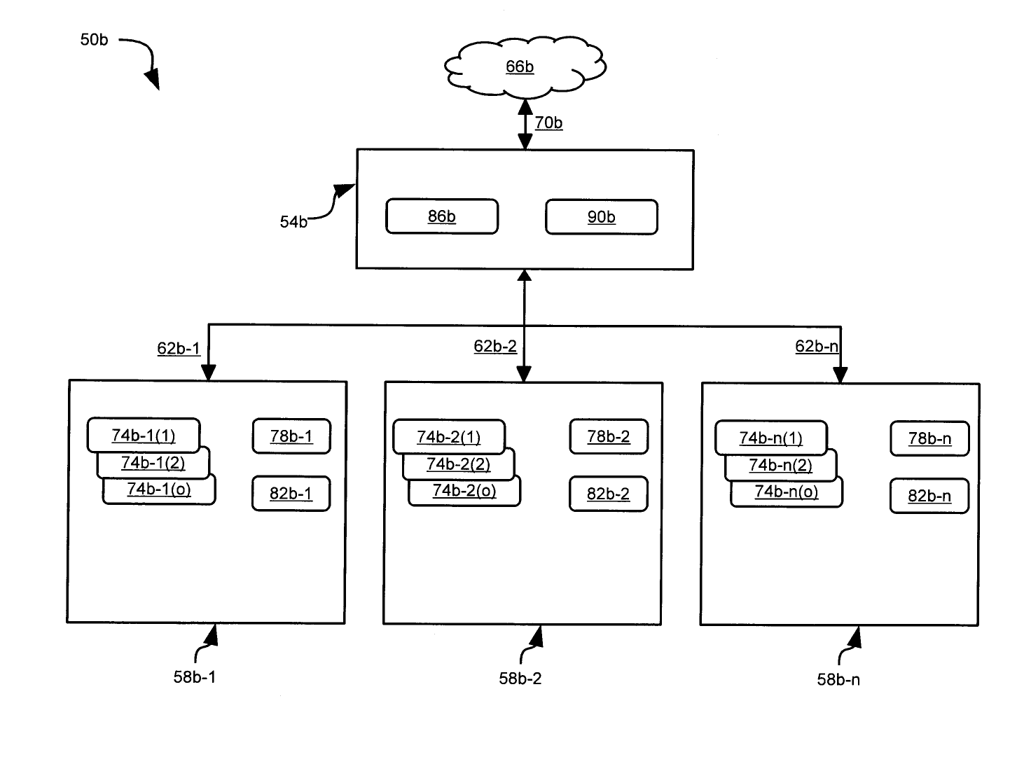

Referring now to FIG. 10, a high availability system in accordance with another embodiment is indicated generally at 50b. System 50b is a variation on system 50 and so like elements bear like references except followed by the suffix “b”.

Of note is that each server 58b in system 50b further comprises a session manager 78b and a recovery manager 82b.

Each session manager 78b is configured to evaluate the overall functioning health of its respective server 58b and to provide logging and effect control over its respective server 58 if any issues arise.

For example, relative to block 255 or block 250, each session manager 78b can be configured such that if it is determined that if a respective server 58b or a respective message processor 74b produces one hundred (100) consecutive minority results or eight thousand five hundred (8500) minority results in one day then that unit shall be considered failed. (The 8500 minority results threshold can be derived from, for example, the requirement for a trading day total message capacity of 8.5×109 transactions, with a required six 9's reliability (0.999999).)

The error conditions can be logged and the failed unit will be removed from the quorum; i.e. its results will no longer be taken into account. Should the failing member be the ‘default master’ then the next available server 58b can be designated as the ‘default master’. Alternatively, this functionality can be effected in part or (as indicated above in relation to system 50) entirely within replicator 54.

Each recovery manager 82b is configured to manage the introduction, or reintroduction, of a particular server 58b into the pathway of processing messages from network 66b during an initialization or a recovery from a failure of that particular server 58b. For example, recovery manager 82b can be used to manage recoveries from block 250, or recoveries that were identified at block 255 when a particular server 58b or message processor 74b was not part of a quorum established as a “yes” determination at block 245.

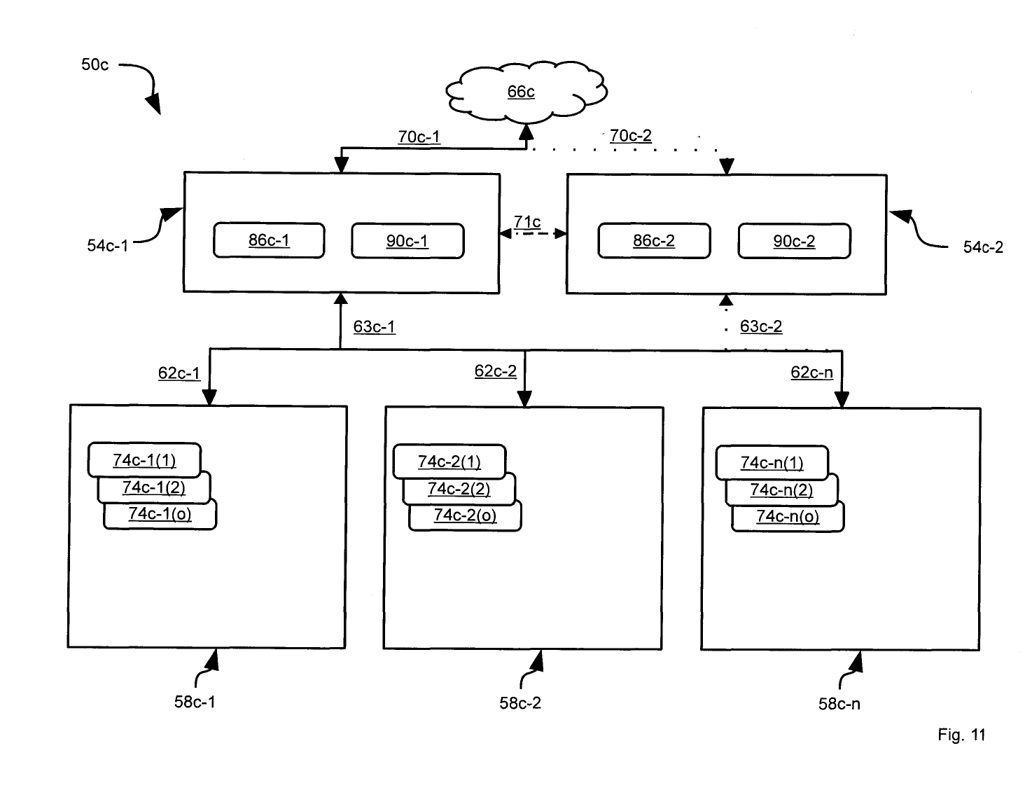

Referring now to FIG. 11, a high availability system in accordance with another embodiment is indicated generally at 50c. System 50c is a variation on system 50 and so like elements bear like references except followed by the suffix “c”. Of note in system 50c is that a secondary replicator 54c-2 is provided. The secondary replicator 54c-2 can help further increase availability in system 50c in the event of a failure of replicator 54c-1. Accordingly, backup link 70c-2 between network 66c and secondary replicator 54c-2 is provided, and a backup link 63c-2 is provided to connect with links 62c in the event of a failure of replicator 54c. A health link 71c (which can be implemented as a dual set of health links, again for redundancy) is also provided, so that each replicator 54c can assess the health of the other and to track which replicator 54c is currently actively forwarding messages according to method 200, and which is in stand-by mode. Thus, where replicator 54c-1 is the primary that is delegated to process messages according to method 200, then replicator 54c-2 is the backup. In the event of a failure of replicator 54c-1, then replicator 54c-2 will assume the active role of processing messages according to method 200.

While the foregoing provides certain non-limiting example embodiments, it should be understood that combinations, subsets, and variations of the foregoing are contemplated. For example, any of the specific features discussed in relation to system 50, message processor 74a, system 50b or system 50c can be individually or collectively combined. Furthermore, although three servers are shown in the above described embodiments, it is to be understood that the systems described above can be modified to include any number of servers. Furthermore, the system can be further modified to include any number of processor response messages generated by the plurality of message processors.

The present specification thus provides a method, device and system. While specific embodiments have been described and illustrated, such embodiments should be considered illustrative only and should not serve to limit the accompanying claims.

1. A high availability system comprising:
a replicator connectable to a network and configured to receive a message from the network and to forward the message;
a plurality of servers connected to the replicator, each of the servers configured to receive the message forwarded by the replicator; and
at least one message processor in each of the servers, the at least one message processor configured to process the message, to generate a processor response message and to return the processor response message to the replicator, wherein the replicator is further configured to generate a validated response message based on the processor response messages,
wherein the replicator is further configured to determine whether each of the processor response messages from the plurality of servers is equal to every other processor response message.

2. (canceled)

3. The high availability system of claim 1, wherein the replicator is further configured to determine whether there is a quorum of equal processor response messages from the plurality of servers.

4. The high availability system of claim 3, further comprising a memory storage unit configured to maintain a failure log file for logging a failure, the failure based on whether there is a quorum.

5. The high availability system of claim 1, wherein the replicator is further configured to associate the message with the at least one message processor.

6. The high availability system of claim 5, wherein the replicator is further configured to match the message with the at least one message processor in an association log file.

7. The high availability system of claim 1, wherein each of the at least one message processors includes a protocol converter configured to convert the message in one of a plurality of protocols into a standardized format.

8. The high availability system of claim 1, further comprising a session manager in each of the servers, the session manager configured to monitor health of each of the servers.

9. The high availability system of claim 1, further comprising a recovery manager in each of the servers, the recovery manager configured to manage the introduction of an additional server.

10. The high availability system of claim 1, further comprising a secondary replicator connectable to the plurality of servers and the network, the secondary replicator configured to assume functionality of the first replicator.

11. A replicator comprising:
a memory storage unit;
a network interface configured to receive a message from a network; and
a replicator processor connected to the memory storage unit and the network interface, the replicator processor configured to forward the message to a plurality of servers, each of the servers configured to process the message, to generate a processor response message, and to return the processor response message, the replicator processor further configured to generate a validated response message based on the processor response messages from the plurality of servers,
wherein the replicator processor is further configured to determine whether each of the processor response messages from the plurality of servers is equal to every other processor response message.

12-16. (canceled)

17. A high availability method, comprising:
receiving, at a replicator, a message from a network;
forwarding the message from the replicator to a plurality of servers, each of the servers having at least one message processor, the at least one message processor configured to process the message, to generate a processor response message, and to return the processor response message to the replicator;
generating, at the replicator, a validated response message based on the processor response messages from the plurality of servers; and
determining whether each of the processor response messages from the plurality of servers is equal to every other processor response message.

18. (canceled)

19. The method of claim 17, further comprising determining whether there is a quorum of equal processor response messages from the plurality of servers.

20. The method of claim 19, further comprising logging a failure in a failure log file, wherein the failure is based on determining whether there is a quorum.

21. The method of claim 17, further comprising associating the message with the at least one message processor.

22. The method of claim 21, wherein associating comprises matching the message with the at least one message processor in an association log file.

23. The method of claim 17, wherein receiving the message comprises receiving the message in one of a plurality of protocols, the message being convertable to a standard format by a protocol converter in at least one of the plurality of message processors.

24. The method of claim 23, further comprising evaluating each of the servers using a session manager configured to monitor health of each of the servers.

25. The method of claim 17, further comprising managing the introduction of an additional server using a recovery manager.

26. The method of claim 17, further comprising assessing health of the replicator using a health link.

27. The method of claim 26, further comprising assuming functionality of the replicator with a secondary replicator when the first replicator fails.
